(19) United States
(12) Patent Application Publication
(10) Pub. No.: US 2011/0262116 A1
(43) Pub. Date: Oct. 27, 2011

(54) INFRARED FILTER OF A LIGHT SOURCE FOR HEATING AN OBJECT

(75) Inventors: Vincent Metzger, Le Mans (FR); Serge Monteix, Nancy (FR); Jerome Martinache, Riedisheim (FR); Hendrick Adrianus Van Sprang, Eindhoven (NL); Cornelius Aarnoud Peter Joziasse, Heusden (NL)

(73) Assignee: SPEZIALLAMPENFABRIK DR. FISCHER GMBH, Diez (DE)

(21) Appl. No.: 13/055,731

(22) PCT Filed: Jul. 16, 2009
(86) PCT No.: PCT/IB2009/053090

§ 371 Date: Feb. 17, 2011

(30) Foreign Application Priority Data
Jul. 25, 2008 (EP) 08300244.4
Sep. 26, 2008 (EP) 08300273.3

(51) Int. Cl. G02B 5/28; F26B 3/30

(52) U.S. Cl. 392/408; 359/359

(57) ABSTRACT

Infrared filler of a light source for healing an object The invention relates to an optical interface for transmitting at least some infrared rays emitted from at least one light source so as to heat an object above a threshold temperature, wherein the object stops to transmit and absorbs from an infrared wavelength threshold, the optical interface comprising: a substrate; an interference filter on the substrate having an infrared spectral transmission T exhibiting: a first portion in the near infrared with high T, a second portion in the far infrared with low T, and an intermediary portion between first and second portions, comprising a spectral transition between high T and low T, having T=50% at a wavelength λ₀ lower than the wavelength threshold; wherein, in a range of wavelengths, the mean value of low T is adjusted so that the light source can provide in this range a complementary heating energy necessary for the total healing temperature of the object exceeds the threshold temperature. The invention also relates to a set of optical interfaces, an optical device, an arrangement of light sources, equipment for blowing performs, and a method of heating perform.

### FIELD OF THE INVENTION

The invention relates to an infrared light source device for heating an object, during a thermal treatment process, in particular a thermal deformation process, for example in a production line.

### BACKGROUND FIELD

For industrial heating applications such as thermal deformation processes like bottle blowing, drying, hardening, rapid thermal processing, etc., light sources like incandescent, Xenon or halogen lamps have typically been in use until now.

For example, the current bottle blowing process uses halogen burners to heat PET pre-forms beyond 100° C., before they are blown.

However, the broad spectra of these lamps makes a skin effect appearing at the outer side of preform due to high absorption of long wavelengths, with the apparition of a corresponding significant thermal gradient between inner and outer preform sides which would lead to a inhomogeneous temperature over the preform volume and thus to an incorrect blowing.

To speeding up the production line, the thermal homogeneity is found rapidly by cooling the outer side (e.g. with a fan or a cooling fluid circuit) until the inner side reaches the right process temperature.

But such cooling systems are cumbersome, noisy and costly.

To overcome this problem, WO 2006/056673 discloses the use of high power density of infrared lasers as well as the selection of emitted wavelength in a shorter range (between 800 nm and 1064 nm) where the absorption by the PET preform is low. The advantage is that the radiation is then absorbed in the whole volume rather than just in a skin.

Nevertheless, this requires a reflector arrangement allowing many passes of laser light through the PET form.

Furthermore, even if such lasers are a promising technology to be used, they are still not efficient enough and still expansive.

### SUMMARY OF THE INVENTION

The invention overcomes the previous drawbacks by providing, in a first aspect, an optical interface for transmitting at least some infrared rays emitted from at least one light source so as to heat an object above a threshold temperature, wherein the object has a low transmission and a high absorption for infrared wavelengths greater than an infrared wavelength threshold, the optical interface comprising:
a substrate;
an interference filter on the substrate having an infrared spectral transmission T exhibiting:
   a first portion in the near infrared with high T,
   a second portion in the far infrared with low T, and
   an intermediary portion between first and second portions, comprising a spectral transition between high T and low T, having T=50% at a wavelength λ₀ lower than the wavelength threshold;
      wherein, in a range of wavelengths starting from the end of the spectral transition to a determinate wavelength, the mean value of low T is adjusted so that the light source can provide in this range such a complementary heating energy that the total heating temperature of the object exceeds the threshold temperature.

According to a second aspect, the invention proposes an optical interface for transmitting at least some infrared rays emitted from at least one light source so as to heat an object above a threshold temperature, wherein the object has a low transmission and a high absorption for infrared wavelengths greater than an infrared wavelength threshold, the optical interface comprising:
a substrate;
an interference filter on the substrate having an infrared spectral transmission T exhibiting:
   a first portion in the near infrared with high T,
   a second portion in the far infrared with low T, and
   an intermediary portion between first and second portions, comprising a spectral transition between high T and low T, having T=50% at a wavelength λ₀ between 150 nm and 350 nm lower than the wavelength threshold;
      wherein, in a range of wavelengths starting from the end of the spectral transition to a determinate wavelength, the mean value of T is between 0.1 to 0.3, this value being adjusted so that the light source can provide in this range such a complementary heating energy that the total heating temperature of the object exceeds the threshold temperature.

Therefore, the invention according to first or second aspect optimises the efficiency of heating processes by selecting appropriate emission bandwidth depending on the optical properties of the object to be heated.

For example it is recommended for the heating stage of objects like PET preforms to have a maximum of supplied infrared energy between the near/medium infrared region (around 1000 nm), a bandwidth presenting a high transmission being suited to minimise the temperature gradient over the preform thickness of such a poor thermal conductive material.

Optional features of the invention according to the first or second aspect of the invention are either of the following features:
the wavelength threshold is about 2250 nm;
the spectral transmission changes from T≧0.90 to T≧0.15 in a wavelength range ≦100 nm;
the interferential filter presents also the following spectral properties: for λε[800; λ₀−50] nm: T≧90%;
the interference filter presents also the following spectral properties: for λ₀+50 nm≦λ≦4000 nm the mean value of T is between 10% and 30%;
the interference filter is a multilayer comprising layers of Fe2O3 and layers of SiO2;
the thickness of the interference filter is about 5 micrometers;
the interference filter also filters out wavelengths below about 700 nm;
the interference filter is further arranged for reflecting back to the light source some non transmitted light.

According to a third aspect, the invention proposes a set of optical interfaces dedicated to be placed in front of at least one light source which emits some infrared wavelengths for heating an object having a determinate thickness placed at a determinate distance from the light source, each optical interface being according to said first or second aspect and having an interference filter with an optical transmitting spectrum different from those of the other optical interfaces, each transmitting spectrum corresponding to a thickness of an object so as to provide an optimum heating of an object having this determinate thickness.

According to a fourth aspect, the invention proposes an optical device comprising:
a light source emitting at least infrared wavelengths, and
an optical interface according to said first or second aspect.

Optional features of this optical device are either of the following features:
the optical device further comprises a light-transmitting lamp vessel in which said light source is arranged, and wherein the lamp vessel is said substrate of the optical interface;
the optical interface is distinct from any light source-integrated device and placed at a determinate distance from the light source.
the optical device further comprises a concave back reflector located on one side of the light source.

According to a fifth aspect, the invention proposes an arrangement of light sources according to a line or matrix of light sources such that the light emitting from the light sources heat a determinate volume placed at a determinate distance from the arrangement, the arrangement further comprising at least one optical interface according to said first or second aspect of the invention.

This arrangement of light sources may further comprise at least one back light reflector placed at one side of the light sources so as to reflect radiations back to the determinate volume.

According to a sixth aspect, the invention proposes an equipment for blowing preforms, comprising the said arrangement of light sources for heating the preforms prior to or during the blowing step, a preform defining the said determinate volume.

According to a seventh aspect, the invention proposes a method of heating a preform, comprising an infrared radiation using at least one optical device according to said fourth aspect of the invention.

These and other aspects of the invention will be apparent from and elucidated with reference to the embodiment(s) described hereinafter.

### BRIEF DESCRIPTION OF THE DRAWINGS

FIG. 1A-1D show schematically four examples of optical systems for heating an object by infrared rays, according to the invention;

FIG. 2 shows a lighting assembly according to the invention;

FIGS. 3a and 3b show a double-ended lamp in accordance with the invention;

FIGS. 4a and 4b show a double-ended lamp in accordance with an advantageous embodiment of the invention;

FIG. 5 shows an emission spectrum of a 2000 W halogen lamp, without any interference filter, and a transmission spectrum of a PET preform heated by such a lamp;

FIG. 6 shows an emission spectrum of a 2000 W halogen lamp, with and without interference filter according to the invention;

FIG. 7 shows an ideal transmission spectrum of a light source associated with two different interference filters;

FIG. 8 is a graph showing comparative temporal evolutions of temperature of the inner and outer sides of a preform when heated by a lamp without filter, a lamp with a 1^{st} filter, and a lamp with a 2^{nd} filter;

FIG. 9 shows different transmission spectrum of respective different interference filters according to the invention.

### DETAILED DESCRIPTION OF THE INVENTION

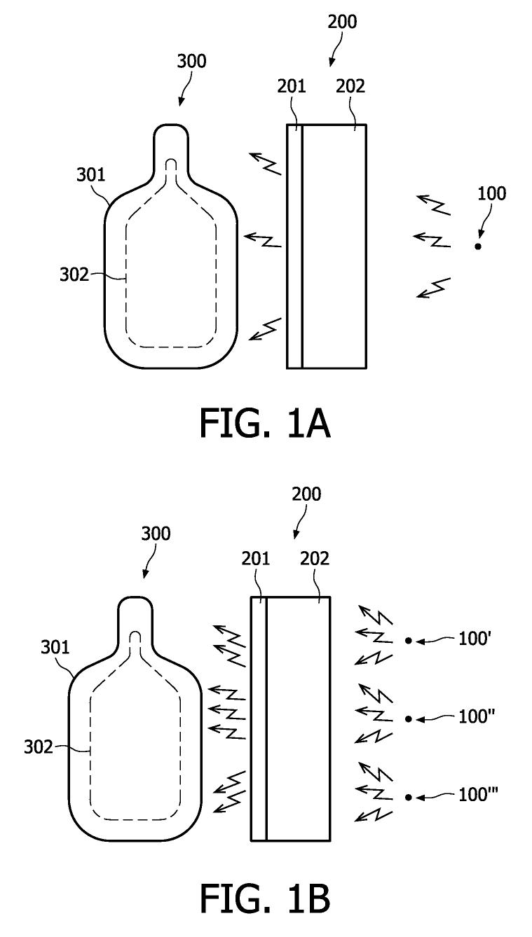

FIG. 1A-1D show schematically four examples of optical systems for heating an object 300 by infrared rays, according to the invention.

This object 300 may be any object needed to be heated, for different applications, e.g. for industrial heating applications such as thermal deformation processes like bottle blowing, drying, hardening, rapid thermal processing. This object 300 can also be a human being, an animal, a plant or a part thereof, who necessitates the application of a thermal energy corresponding to a certain threshold temperature brought to the whole body, for well-being or medical purpose.

Without limitation to the scope of the invention, the object 300 in the subsequent description is a preform to be heated and blown (simultaneously and/or after the heating) into a final container (e.g. a bottle). “Preform” means any preform as well as any intermediary container between the preform and the final container. Indeed particular industrial process may comprise a first step of forming an intermediary container from the preform, then, after a determinate time, a second step of forming a final container from the intermediary container. To perform such blowing or part of blowing, a certain thermal energy has to be brought to the preform (or to the intermediary container) 300. In this example, the preform 300 comprises an outer surface 301 and an inner surface 302 defining an outer wall with a specific thickness.

The optical systems of FIG. 1A-1D may be part of an installation for blowing containers from preforms 300, e.g. preforms in thermoplastic material such as for example polyethylene therephtalate (PET), polyethylene naphtalate (PEN), or other kind of appropriate thermoplastic material. This installation may be part of a production line comprising a feeding unit for feeding material, with a determinate pace, to a forming unit. The preforms 300 formed in the forming unit may therefore be mounted on a transfer line, then heated in a heating unit while still being in motion on the transfer line, before being introduced, in a hot state, in a blowing unit (not shown). The installation depicted by FIG. 1A-1D may be part of a heating unit.

Due to efficiency of such an industrial process, it is desirable to obtain a heating efficient and rapid: this is the main purpose of the optical system of the invention.

The optical system of FIG. 1A comprises:
a light source 100 for emitting at least some infrared rays;
an optical interface 200 placed between the light source 100 and the preform 300, which optical interface 200 comprises a substrate 202 and an interference filter 201 on the substrate 202.

The light source 100 is able to emit infrared lights with energy sufficient to heat the preform 100 according to industrial requirements. Possibly, the light source 100 emits other kinds of wavelengths, such as for example wavelengths in the visible range. The light source 100 can be of any kind, such as for example an incandescent, halogen, Xenon lamp, or a LED.

Light source 100 is located so as to heat homogeneously the preform 300, i.e. on the whole length, on the whole circumference, on the whole thickness.

The substrate 202 is preferably transparent to at least near infrared. It can be made for example of amorphous, polycrystalline, nanocrystalline glass or quartz.

The interference filter 201 is arranged for cutting-off some wavelengths from the emitting spectra so as to optimise the heating of the preform 300 according to the invention. Preferably the interference filter 201 reflects the undesirable wavelengths back to the light source 300. The interference filter 201 is designed to heat homogeneously, quickly and sufficiently the preform 300, and especially to obtain a rapid thermal equilibrium between the inner side 302 and of the outer side 301 of the preform 300 necessary for blowing.

Alternatively, the heating of the preform 300 may be provided with a plurality of light sources 100′, 100″, 100′″ (FIG. 1B, 1C, 1C), fixed or mobile around the preform 300, that may be arranged according to a row, a column or a matrix, facing one side of the preform 300, or several sides of the preform 300, or all the sides of the preform 300, so as to heat homogeneously the preform 300, i.e. on the whole length, on the whole circumference, on the whole thickness.

A single optical interface 200 may be provided for all the light sources 100′, 100″, 100′″ (FIG. 1B) or several optical interfaces 200′, 200″, 200′″ may face at least one light source 100′, 100″, 100′″ (FIG. 1C).

One infrared reflector 400′, 400″, 400′″ may be provided at the backside of each light source 100′, 100″, 100′″ (FIG. 1D) or at the backside of a plurality of light sources (not shown). These reflectors allows to use all the lighting energy emitted by the light source 100, including the light emitted backwardly, for heating the preform 300. At least a part of the reflectors 400′, 400″, 400′″ might be parabolic of revolution if it is dedicated to reflect light from a single light source 100′, 100″, 100′″ located at the focus point of the parabola. Alternatively, at least a part of the reflectors 400′, 400″, 400′″ might have a parabolic cross-section extending along an axis if it is dedicated to reflect light from a line of light sources 100′, 100″, 100′″ located at the focus line of the reflector.

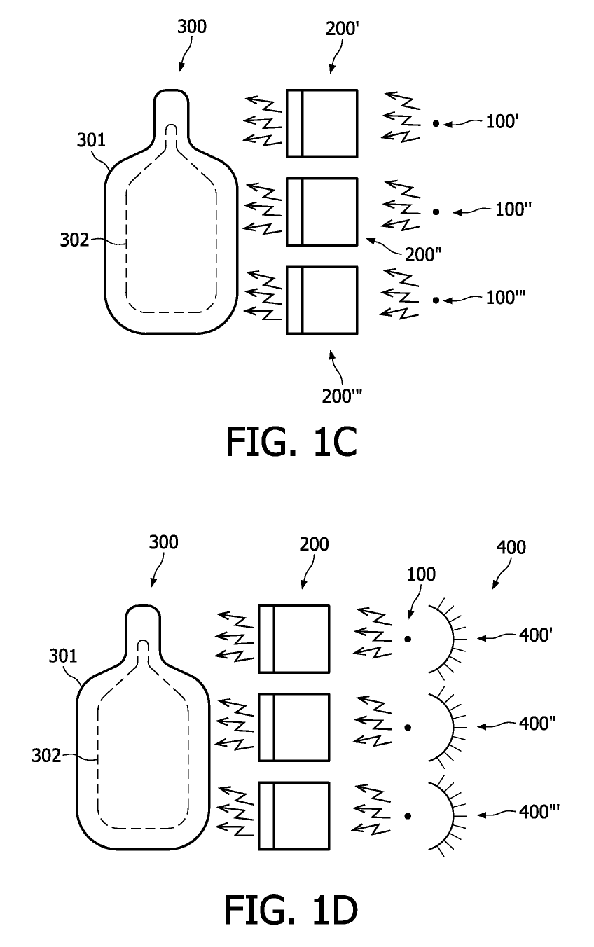

On FIG. 2, it is depicted a lighting assembly comprising a housing 500 having lateral reflective walls, a light reflective parabolic rear wall 400 and an opened front face closed by the optical interface 200. A light source 100 or a line of light sources is arranged within the housing 500 so as to be located at the focus of the parabola. With this assembly, the light sources are protected from dust and can be easily integrated in an industrial installation.

The interference filter 201 may be formed either on a substrate 202 separate from the light source 100 or on a part of the light source 300 such as for example the vessel of an incandescent lamp or on the optics of a LED.

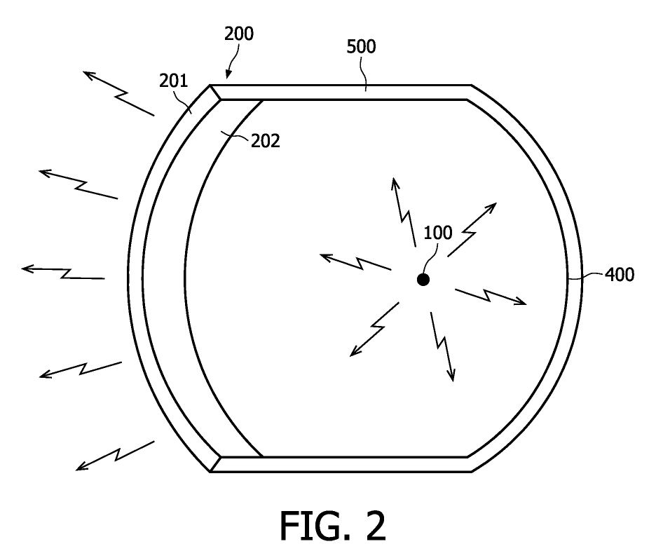

An example of a double-ended lamp coated with an interference filter 201 in accordance with the invention is depicted in FIGS. 3a and 3b. FIG. 3b is an enlarged cross-section in the plane BB of FIG. 3a. This lamp comprises a lamp vessel 101, an incandescent body 102, current supply conductors 103 and an outer envelope 104. The lamp further comprises caps 105, shells 106, foils 107, supports 108, current wires 109 and an exhausting pipe 110. A reflective film 111 is deposited on the outer envelope 104.

The incandescent body 102, which is for example a tungsten wire, has its extremities connected to the foils 107, which are for example pieces of molybdenum to which the extremities of the incandescent body 102 are welded.

Current supply conductors 103 are also welded to the foils 107. The current supply conductors are connected to the current wires 109. This can be done by welding a current supply conductor 103 to a current wire 109, through a hole of a cap 105.

Such a cap 105 is described in patent EP 0345890. Alternatively, the extremity of the incandescent body 102 serves as current supply conductor and is directly connected to the current wire 109. The incandescent body 102 is maintained in position inside the lamp vessel 101, by means of the supports 108, which permit a right positioning of the incandescent body 102 in the lamp vessel 101.

The lamp vessel 101 is filled with a high-pressure discharge gas, such as argon, and comprises a small quantity of a halide substance in order to prevent darkening of the lamp vessel 101, due to deposition of gaseous tungsten.

As the lamp of FIGS. 3a and 3b is used for heating, it utilizes a relatively high wattage, which is typically more than 1000 watts, so that some parts of the lamp such as the lamp vessel 101 are submitted to relatively high temperature, typically around 1000° C. To avoid that such a high temperature deteriorate the interference filter 201, the interference filter 201 in the lamp in accordance with the invention is deposited on the outer envelope 104 (which is thus the said substrate 202 of FIG. 1A). This outer envelope 104, which is farther from the incandescent body 102 than the lamp vessel 101, reaches lower temperatures, so that the interference filter 201 is not degraded. The diameter of the lamp vessel 101 can thus be kept as small as desired, as the degradation of the reflective film does not depend on said diameter. The wattage of the lamp can also be increased, without risks of degradation of the interference filter 201. Such a lamp can thus have increased linear power densities, without decreasing its lifetime.

It should be noted that the interference filter 201 can be deposited on an external face of the outer envelope 104, or on an inner face of the outer envelope 104, or can be a combination of a reflective film deposited on the external face of the outer envelope 104 and a reflective film deposited on the inner face of the outer envelope 104.

Moreover, the outer envelope 104 is particularly advantageous. In case of lamp failure or even explosion of the lamp vessel, thanks to the outer envelope 104, any glass pieces that may fall off safely remain inside the outer envelope 104, so that the persons using such a lamp cannot be injured.

In FIGS. 3a and 3b, the outer envelope 104 is a tube, for example of quartz or glass, on which the reflective film is deposited.

It can be noticed that the lamp of FIGS. 3a and 3b can comprise an additional film, which is deposited on the inner or the outer face of the lamp vessel 101. This additional film should resist at higher temperatures than the interference filter 201, in order not to be degraded. This allows using different filterings in a same lamp.

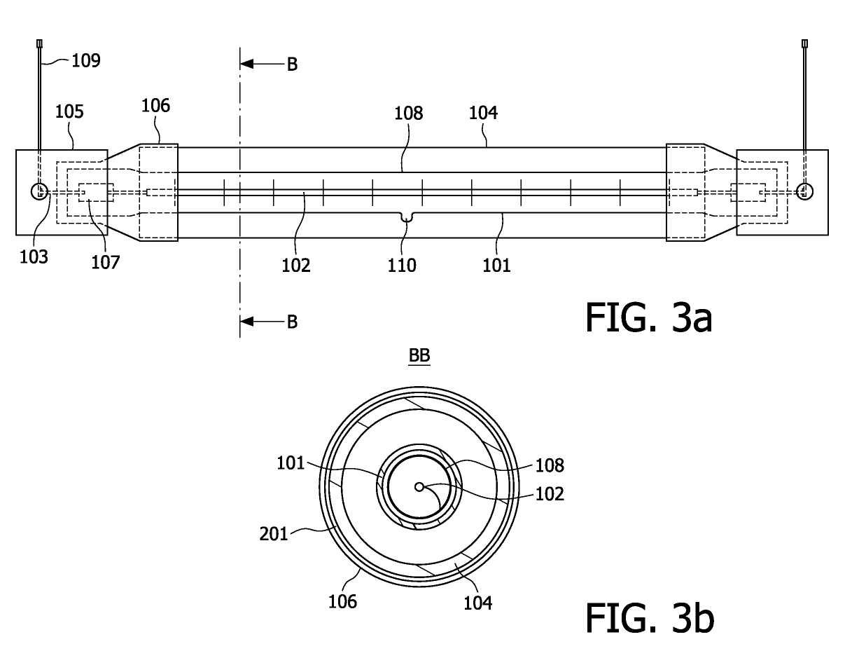

A double-ended lamp in accordance with another embodiment of the invention is depicted in FIGS. 4a and 4b. FIG. 4b is an enlarged cross-section in the plane BB of FIG. 4a. The lamp depicted in FIGS. 4a and 4b comprises the same elements as the lamp of FIGS. 3a and 3b. The lamp of FIGS. 4a and 4b further comprises a reflective layer 400 deposited on a part of the lamp vessel 101. Such a reflective layer 400 is known from those skilled in the art. For example, a gold reflective layer can be deposited on the lamp vessel 101, by means of conventional techniques, such as vapor deposition. Preferably, the reflective layer 400 is a ceramic reflective layer.

Such a ceramic reflective layer is used, for example, in a halogen lamp sold by the applicant under reference 13195Z/98.

Such a ceramic reflective layer 400 has the advantage that it resists at relatively high temperatures, such as 2000° C. This is particularly advantageous in the lamps in accordance with the invention, which operating temperatures can be above 1000° C., depending on the linear power density.

Such a reflective layer 400 provides focalization of the radiation beams emitted by the incandescent body 102, which is necessary in order to direct the radiation beam to a person or an object to heat. As a consequence, no external reflector is required, which is an advantage, because such an external reflector is bulky and limits the compactness of the lamp system.

It should be noted that the reflective layer 400 can be deposited on an internal face of the lamp vessel 101, instead of being deposited on an external face, as depicted on FIGS. 4a and 4b.

In some lamps, it is not possible to provide such a reflective layer 400 on the lamp vessel, because the lamp vessel already comprises a reflective film. As a consequence, in order to focus the heat, these lamps can be used in combination with an external reflector 400.

Whatever its configuration and the substrate on which it is formed, the interference filter 201 is preferably a multilayer comprising layers of, alternately, a first layer of a material having a comparatively high refractive index and a second layer of a material having a comparatively low refractive index.

Optionally the second layer of the interference filter comprises predominantly silicon oxide, and the first layer of the interference filter comprises predominantly a material having a refractive index which is high as compared to a refractive index of silicon oxide.

Preferably, the first layer of the interferential filter comprises a material chosen from the group formed by titanium oxide, tantalum oxide, zirconium oxide, niobium oxide, hafnium oxide, silicon nitride and combinations of said materials. Preferably, the material of the first layer of the interferential filter predominantly comprises titanium oxide or niobium oxide.

Preferably, the interference filter 201 is TiO2/SiO2 type-films or Nb2O5/SiO2-type films.

The interference filter 201 may be provided in a customary manner by means of 1. physical vapor depostion (PVD), e.g. reactive magnetron sputtering or evaporation, 2. chemical vapor deposition (CVD), e.g. low pressure CVD (LPCVD), plasma enhanced CVD (PECVD), plasma impulse CVD (PICVD), 3. wet chemical deposition techniques, e.g. sol gel coating by spraying and dipping.

The interference filter 201 may have typically a thickness around 5 micrometers.

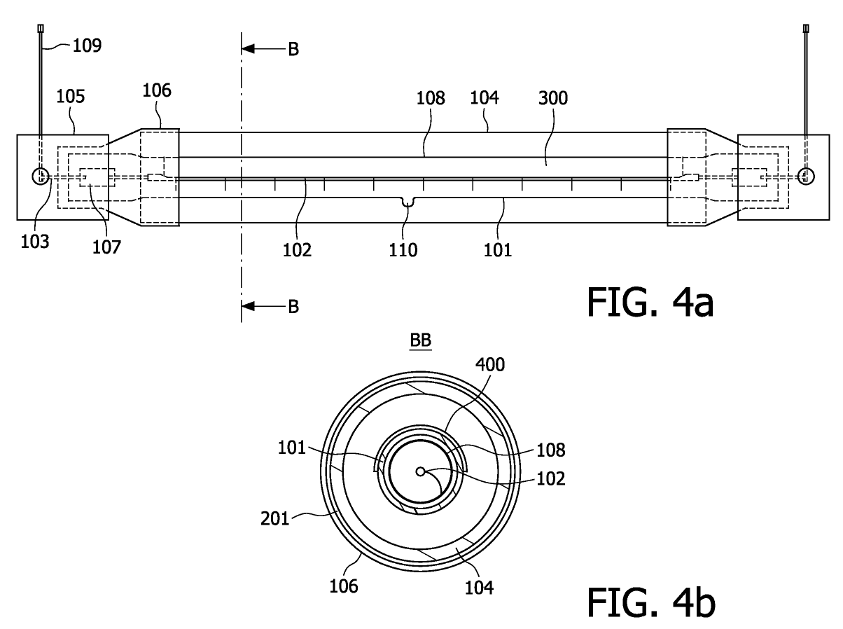

FIG. 5 is a graph showing the emission spectrum of the 2000 Watts halogen lamp of FIGS. 3a and 3b but without any interference filter 201 (black curve) and the corresponding transmission curve of a PET preform receiving the radiation from such a lamp (grey curve).

This graph shows that the PET plastic becomes nearly completely opaque for wavelengths above 2250 nm. This is due to the high absorption level of PET above this range.

So, when heating a plastic PET preform with wavelengths greater than 2250 nm, the high absorption leads to overheat the outer side 301 and to under-heat the inner side 302 (see FIG. 1A), which it is called the said “skin effect”.

This graph shows also that the transmission curve of PET comprises a 1^{st} level of transmission (at around 90 a.u.) in the range 400-1600 nm much higher than an intermediary level of transmission (at around 40 a.u.) in the range 1600-2250 nm.

This intermediary level of transmission shows an intermediary level between transparency (1^{st} level) and total opacity (for wavelengths greater then 2250 nm) for which absorption and transmission of the wavelengths through the preform 300 are moderate.

To properly blow a plastic container (such as a bottle) the PET should be homogeneously heated between 100° C. and 130° C., since above 130° C.: the PET cristallizes.

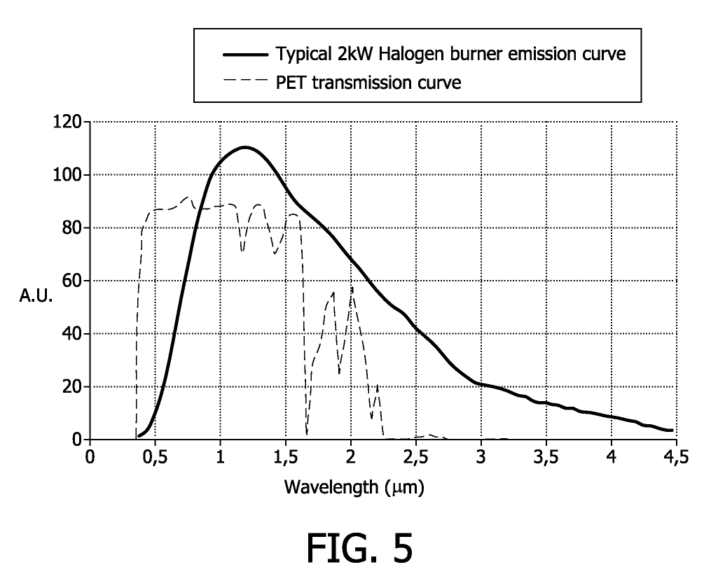

Instead of cooling the outside surface 301 of the PET preform, by using fans, the invention proposes to provide an interference filter 201 that removes most of the light emission above 2250 nm and keeps as much as possible below 2250 nm. This is depicted by FIG. 6 showing comparatively the emission spectrum with such an interference filter 201 (black curve) and the emission spectrum without such an interference filter 201 (grey curve). It is noticed that the interference filter 201 is arranged for cutting-off at 2000 nm and for only keeping about 20% of the spectrum without filter in the range 2000-2250 nm: in such a configuration, wavelengths between 2000-2250 nm reach the preform 300. Such wavelengths belonging to the said intermediary level as recited for FIG. 5, the light absorbed by the preform 300 stays moderate and the skin effect that is brought about by this absorption is therefore also moderate comparing with absorption brought about wavelengths above 2250 nm. Thus, by using these intermediary wavelengths (between 2000-2250 nm), and by attenuating their energy comparing with a case for which they are all cut-off, it is possible to increase the heating of the preform 300 while preventing the appearing of a significant skin effect.

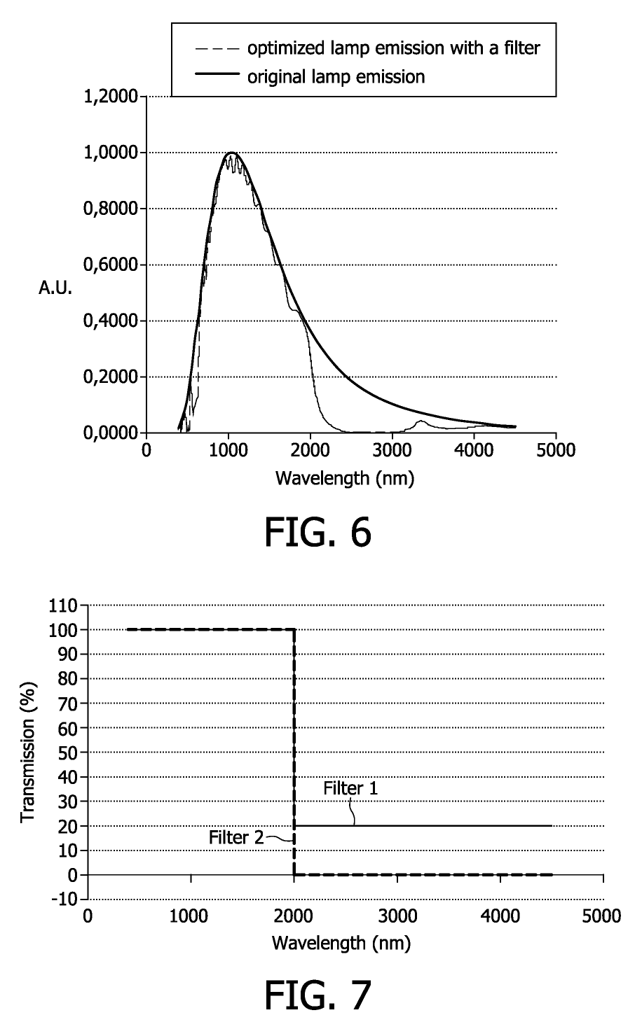

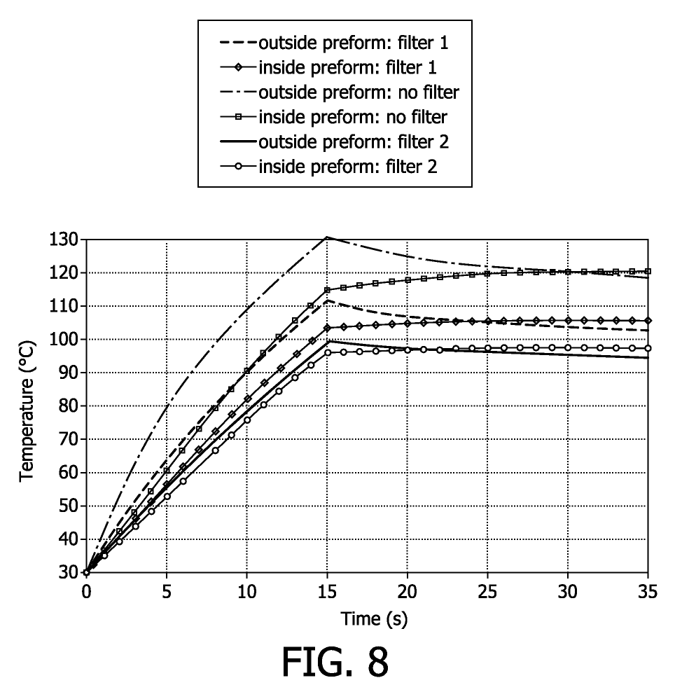

The advantage of these intermediary wavelengths for preparing the blowing of a PET preform 300 is shown on FIGS. 7 and 8.

FIG. 7 shows the transmission spectrum of a lamp coated with an interference filter n^{o} 1 (curve 1) and of the same lamp coated with an interference filter n^{o} 2 (curve 2). Filter n^{o} 1 and 2 have both a transmission T at 100% before 2000 nm, and a transmission T at 20% after 2000 nm for filter n^{o} 1 and a transmission T at 0% after 2000 nm for filter n^{o} 2. Therefore the cut-off at 2000 nm is total for filter n^{o} 2 while it is partial for filter n^{o} 1.

FIG. 8 is a graph showing the temporal evolution of the temperature on the inner side 302 and outer side 301 of a PET preform 300, from the starting of light emission (time=0 second) by lamps. The tested lamps are: 1. lamp coated with filter n^{o} 1; 2. lamp coated with filter n^{o} 2; 3. lamp not coated by any filter.

It is shown that:
lamp with filter n^{o} 1 does not reach the 100° C. necessary for blowing a bottle, and is therefore not useable; that
the no-filter lamp allows the heating of the preform 300 within the range 100-130° C. required for blowing bottles without crystallization, but needs at least 25 seconds before the inner and outer sides of the preform 300 are stabilized at a same temperature (about 120° C.); and that
the lamp with filter n^{o} 2 allows the heating of the preform 300 within the range 100-130° C. required for blowing bottles without crystallization, and needs only 21 seconds before the inner and outer sides of the preform 300 are stabilized at a same temperature (about 105° C.).

This example shows that the filter n^{o} 2 optimises the heating of the preform 300, by speeding up the homogeneous heating (between inner and outer sides of the preform 300) while ensuring a sufficient heating temperature for blowing issue.

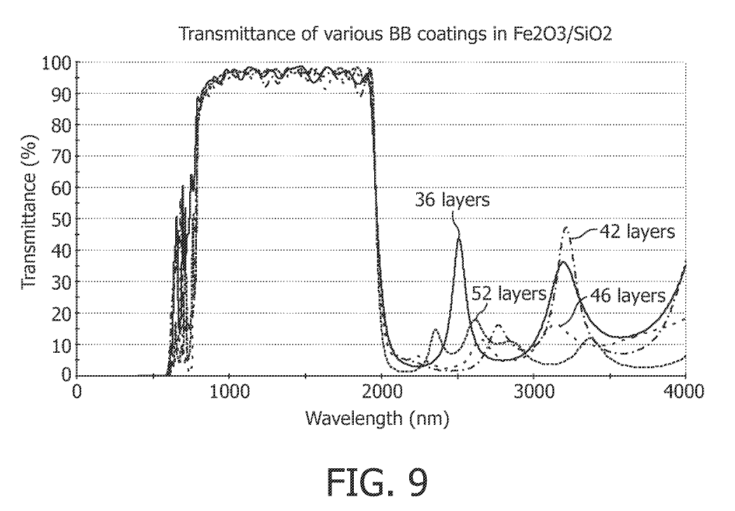

Furthermore the interference filter 201 according to the invention can be designed so as to keep an appropriate transmission rate beyond the cut-off wavelength (i.e. 2000 nm here) so as to reach a temperature equal to or greater than the threshold temperature (i.e. 100° C. here) and to obtain rapidly (i.e. 21 seconds here) a homogeneous heating (i.e. between inner side 302 and outer side 301 of the preform 300), and therefore optimising the industrial heating of the preform 300 in view of the next and/or simultaneous blowing step. To this purpose, and in view of FIG. 9, it is possible for example to amend the number of layers in a Fe2O5/SiO2 interference filter 201 for obtaining different transmission values beyond 2000 nm, while keeping a same level before 2000 nm.

Example of a 42 layered-interference filter 201 according to the invention (those from which the corresponding curve on FIG. 9 has been obtained), coated by PVD on a clear halogen lamp (2500 W-400V) with a ceramic reflector on the rear side, is detailed in the following table:

| | | Thickness |
|---|---|---|
| Layer | Material | (nm) |
| Substrate | SiO2 | |
| 1 | Fe2O3 | 28 |
| 2 | SiO2 | 59 |
| 3 | Fe2O3 | 219 |
| 4 | SiO2 | 47 |
| 5 | Fe2O3 | 22 |
| 6 | SiO2 | 363 |
| 7 | Fe2O3 | 26 |
| 8 | SiO2 | 42 |
| 9 | Fe2O3 | 209 |
| 10 | SiO2 | 50 |
| 11 | Fe2O3 | 33 |
| 12 | SiO2 | 732 |
| 13 | Fe2O3 | 32 |
| 14 | SiO2 | 54 |
| 15 | Fe2O3 | 204 |
| 16 | SiO2 | 33 |
| 17 | Fe2O3 | 28 |
| 18 | SiO2 | 361 |
| 19 | Fe2O3 | 22 |
| 20 | SiO2 | 37 |
| 21 | Fe2O3 | 198 |
| 22 | SiO2 | 55 |
| 23 | Fe2O3 | 20 |
| 24 | SiO2 | 308 |
| 25 | Fe2O3 | 30 |
| 26 | SiO2 | 65 |
| 27 | Fe2O3 | 75 |
| 28 | SiO2 | 61 |
| 29 | Fe2O3 | 36 |
| 30 | SiO2 | 347 |
| 31 | Fe2O3 | 21 |
| 32 | SiO2 | 47 |
| 33 | Fe2O3 | 193 |
| 34 | SiO2 | 23 |
| 35 | Fe2O3 | 16 |
| 36 | SiO2 | 154 |
| Medium | Air | |

| | |
|---|---|
| Total Thickness | 4249 |

Optionally, the interference filter 201 is also configured to filter out (e.g. by reflection) a large part of the visible radiation emitted by the light source 100.

Indeed, this visible radiation reflected back by the interference filter 201 can be reabsorbed by a halogen lamp for being reemitted later on through infrared radiation. This allows saving energy. This energy saving is enhanced if a reflector 400 is provided on the backside of the light source 100.

Moreover, the non-emission of visible wavelengths may be desirable, e.g. for avoiding any glaring effect that may affect people close to the optical system.

The interference filters 201 corresponding to the spectrum of FIG. 9, provide such filtering out of the visible light—notice the cut-off around 800 nm.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1-19. (canceled)

20. An optical interface for transmitting at least some infrared rays emitted from at least one light source so as to heat an object above a threshold temperature, wherein the object has a low transmission and a high absorption for infrared wavelengths greater than an infrared wavelength threshold, the optical interface comprising:
a substrate; and
an interference filter on the substrate having an infrared spectral transmission T exhibiting:
a first portion in the near infrared with high T,
a second portion in the far infrared with low T, and
an intermediary portion between the first and second portions, comprising a spectral transition between high T and low T, having T=50% at a wavelength λ₀ between 150 nm and 350 nm lower than the infrared wavelength threshold,
wherein, in a range of wavelengths starting from the end of the spectral transition to a determinate wavelength between λ₀ and the infrared wavelength threshold, the mean value of T is between 0.1 to 0.3.

21. The optical interface of claim 20, wherein the infrared wavelength threshold is about 2250 nm.

22. The optical interface of claim 21, wherein the determinate wavelength is 2000 nm.

23. The optical interface of claim 20, wherein the determinate wavelength is 2000 nm.

24. The optical interface of claim 20, wherein the spectral transmission changes from T≧0.90 to T≦0.15 in a wavelength range 100 nm.

25. The optical interface of claim 20, wherein the interferential filter presents also the following spectral properties: for λε[800; λ₀−50] nm: T≧90%.

26. The optical interface of claim 20, wherein the interferential filter presents also the following spectral properties: for λ₀+50 nm≦λ≦4000 nm the mean value of T is between 10 and 30%.

27. The optical interface of claim 20, wherein the interference filter is a multilayer comprising layers of Fe2O3 and layers of SiO2.

28. The optical interface of claim 20, wherein the thickness of the interference filter is about 5 micrometers.

29. The optical interface of claim 20, wherein the interference filter also filters out wavelengths below about 700 nm.

30. The optical interface of claim 20, wherein the interference filter is further arranged for reflecting back to the light source some non transmitted light.

31. An optical device comprising:
a light source emitting at least infrared wavelengths, and
an optical interface according to claim 20.

32. The optical device of claim 31, further comprising a light-transmitting lamp vessel in which said light source is arranged, and wherein the lamp vessel is said substrate of the optical interface.

33. The optical device of claim 31, wherein the optical interface is distinct from any light source-integrated device and placed at a determinate distance from the light source.

34. The optical device of claim 31, further comprising a concave back reflector located on one side of the light source.

35. A method of heating a preform, comprising an infrared radiation using at least one optical device according to claim 31.

36. A method of claim 35, wherein the preform is made from thermoplastic material.

37. The method of claim 36, wherein the preform is made from PET.

38. The method of claim 37, wherein the preform is a container.

39. The method of claim 35, wherein the preform is made from PET.

40. The method of claim 39, wherein the preform is a container.

41. The method of claim 35, wherein the preform is a container.
